(19) United States
(12) Patent Application Publication
(10) Pub. No.: US 2006/0077482 A1
(43) Pub. Date: Apr. 13, 2006

(54) Light-gathering structure for scanning module

(75) Inventor: Ling Ta Su, Chiayi City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Creative Sensor Inc., Sindian City (TW)

(21) Appl. No.: 11/065,206

(22) Filed: Feb. 24, 2005

(30) Foreign Application Priority Data
Oct. 13, 2004 (TW) 093131054

(51) Int. Cl. H04N 1/04

(52) U.S. Cl. 358/475

(57) ABSTRACT

A light-gathering structure for a scanning module is disclosed. The light-gathering structure for a scanning module having at least a scanning area, a lens and a light-sensing element includes at least an elliptic arc surface having a first focus; at least a circular arc surface having a circular center being superpositioned on the first focus; and at least a light source positioned at the first focus, wherein a light from the light source is reflected by the elliptic arc surface and the circular arc surface to the scanning area and converged on the light-sensing element through the lens.

### FIELD OF THE INVENTION

This invention relates to a light-gathering structure for a scanning module, and more particularly to a light-gathering structure for increasing the light flux density on the scanning area of the scanning module.

### BACKGROUND OF THE INVENTION

In operation of a scanner, light is emitted from a source to a object, then is reflected by a set of lens. Then, the light is focused on and received by a charge-couple device (CCD) or a complementary metal oxide semiconductor (CMOS). The light signal is transferred into electric signal by such light-sensing component, so that data of analog or digital pixels are produced. Generally, the light source can be the light emitting diodes (LED), the fluorescent lamp, the cold cathode fluorescent lamp (CCFL) or the particular lamp such as the xenon lamp.

There are two types of the scanning modules. One is the contact image sensor module (CISM) including the light-sensing element, the rod lens, the light source and the cover glass. The other is the charge coupled device module (CCDM) including the sensing element, the lens, the mirror, the light source and the cover glass.

Please refer to FIG. 1, which is the schematic view showing the operation of the conventional contact image sensor module (CISM). The scanning module 10 includes the cover glass 11, the light source 12, the first light reflecting surface 131, the rod lens 14, the light-sensing element 15, the circuit board 16 and the housing 17. In the scanning module having the light tube as the light source, the light-gathering structure is formed by the curve shaped light reflecting surface 131. As shown in FIG. 1, there is only some effective light 181 directly emitted to the scanning area 19 or reflected by the first light reflecting surface 131 to the scanning area 19. Most ineffective light 182 can not be guided to the scanning area 19. Please refer to FIG. 2, which is the schematic view showing the operation of the improved contact image sensor module (CISM) of FIG. 1. The elements in FIG. 2 are similar to those in FIG. 1 except the planar (or curve shaped) second light reflecting surface 232 added above the first light reflecting surface 231 for increasing the amount of the effective light 281 reflected to the scanning area 29; even so, there is still much ineffective light 282.

Please refer to FIG. 3, which is the schematic view showing the conventional charge coupled device module (CCDM). The scanning module 30 includes the cover glass 31, the light source 32, the first light reflecting surface 331, the lens 34, the light-sensing element 35, the circuit board 36 and the mirror 37. Similarly, in the scanning module 30, the light-gathering structure is formed by the curve-shaped light reflecting surface 331. As shown in FIG. 3, there is only some effective light 381 directly emitted to the scanning area 39 or reflected by the first light reflecting surface 331 to the scanning area 39. Most ineffective light 382 cannot be guided to the scanning area 39.

Please refer to FIG. 4, which is the schematic view showing the operation of the improved charge coupled device module (CCDM) of FIG. 3. The elements in FIG. 4 are similar to those in FIG. 3 except the planar (or curve shaped) second light reflecting surface 432 added above the first light reflecting surface 431 for increasing the amount of the effective light 481 reflected to the scanning area 49; even so, there is still much ineffective light 482.

Please refer to FIG. 5, which is a schematic view showing the light-gathering structure according to the US patent publication No. 20040080796 A1. The light emitted from the light source 52 is transferred to the parallel light by the particular light-reflecting element 531 with the curved surface, and the parallel light is guided to the scanning area 59 via the plane mirror 532, the lenses 533 and the mirror 534.

However, there are too many elements needed in the light-gathering structure in the scanning module shown in FIG. 5, and furthermore the cost of the light-gathering structure is high and the assembly of the light-gathering structure should be with great precision. In addition, the mirror 534 is disposed on the scanning module 50 and the light source 52 is fixed, so that when the scanning module 50 is near or away from the light source, the light intensity on the scanning area 59 is different due to the light intensity being proportional to the transmitting distance of the light. Moreover, for the light-gathering structure shown in FIG. 5, the weaker light intensity around the two ends of the light tube is not considered, hence the optimal image quality cannot be obtained.

Please refer to FIGS. 6(a) and 6(b), which are the schematic views showing the light-gathering structure according to the Taiwan patent No. 563339. The light tube 60 (the light source) except the slot 62 is coated externally with the completely reflective material 61. While the light produced inside the light tube is emitted to the outside of the light tube 60, the light is repetitively reflected by the completely reflective material 61 in the light tube 60, and then the light is emitted outside the light tube via the slot 62 as shown in FIG. 6(a). In addition, the auxiliary light sources 63 are positioned beside the light tube 60 for increasing the light intensity so as to improve the uniformity of the light.

However, the cost of the light-gathering structure is high due to the coating of the completely reflective material 61 and the auxiliary light source 62, and the energy of the light is absorbed by the wall of the light tube due to the repetitive reflections of the light, so that the temperature of the light tube 60 is increased and the scanning module is deformed so as to influence the image quality. Furthermore, the uniformity of the light emitted from the slot 62 cannot be effectively controlled. The image quality obtained from the scanning module with the light-gathering structure shown in FIGS. 6(a) and 6(b) is not desired.

According to the foresaid descriptions, there is only some light on the scanning area via the current light-gathering structure for the current scanning module, and the light intensity on the scanning area cannot be increased by the insufficient energy of the light. With regard to the techniques disclosed in the US patent publication No. 20040080796 A1 and the Taiwan patent No. 563339, the cost is high and the light quality produced therefrom does not fulfill the requirements of the scanning module for producing the image with high quality.

Therefore, the present invention provides a light-gathering structure for the scanning module to overcome the disadvantages of the prior art described above.

### SUMMARY OF THE INVENTION

It is an aspect of the present invention to provide a light-gathering structure for the scanning module. In accordance with the present invention, the light-gathering structure includes the elliptic arc surface and the circular arc surface for reflecting the light emitted from the light source and for guiding the light to the scanning area. After the light is reflected and guided to the scanning area, the light is scattered to the light-sensing element (CCD or COMS) in the scanning module to be transferred into the image.

In accordance with the present invention, the elliptic arc surface has two foci, the light source is positioned on the first focus, which is also the circular center of the circular arc surface, and the second focus of the elliptic arc surface is positioned in response to the position of the scanning area and the refractive index of the cover glass. The light emitted from the light source can be subdivided into four sets. The first set of light is directly emitted to the second focus; the second set of light is reflected to the second focus by the elliptic arc surface; the third set of light is emitted from the light source, reflected by the circular arc surface to the circular center, and then guided by the elliptic arc surface to the second focus; and the fourth set of light is the ineffective light, which is rare in the present invention. The second and the third sets of light are guided to the scanning area via the combination of the elliptic arc surface and the circular arc surface, so that the light intensity on the scanning area is increased.

In accordance with the present invention, the reflective films can be attached on the elliptic arc surface and the circular arc surface, or the reflective material can be coated on the elliptic arc surface and the circular arc surface for increasing the intensity of the reflected light. In addition, the reflective films with the relatively high reflective index are disposed around the two ends of the light tube or the materials with the high reflective index are coated around the two end of the light tube for enhancing the light reflections and increasing the light intensity around the two ends of the light tube. Furthermore, the circular arc surface can be positioned on the end of the light source. Accordingly, the illumination on the scanning area is uniform.

In accordance with the present invention, the elliptic arc surface can be integrally formed on the housing of the scanning module, and the circular arc surface can be assembled on the housing of the scanning module. Moreover, two light-gathering structures of the present invention can be used for one scanning module, and positioned at the left side and the right side below the scanning area.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view showing the operation of the conventional contact image sensor module (CISM);

FIG. 2 is a schematic view showing the operation of the improved contact image sensor module (CISM) of FIG. 1;

FIG. 3 is a schematic view showing the conventional charge coupled device module (CCDM);

FIG. 4 is a schematic view showing the operation of the improved charge coupled device module (CCDM) of FIG. 3;

FIG. 5 is a schematic view showing the light-gathering structure according to the US patent publication No. 20040080796 Al;

FIGS. 6(a) and 6(b) are schematic views showing the light-gathering structure according to the Taiwan patent No. 563339;

FIG. 7 is a schematic view showing the light-gathering structure for the scanning module according to the first embodiment of the present invention;

FIG. 8 is a schematic view showing the light-gathering structure for the scanning module according to the second embodiment of the present invention;

FIG. 9 is a schematic view showing the light-gathering structure for the scanning module according to the third embodiment of the present invention; and

FIG. 10 is a schematic view showing the light-gathering structure for the scanning module according to the fourth embodiment of the present invention.

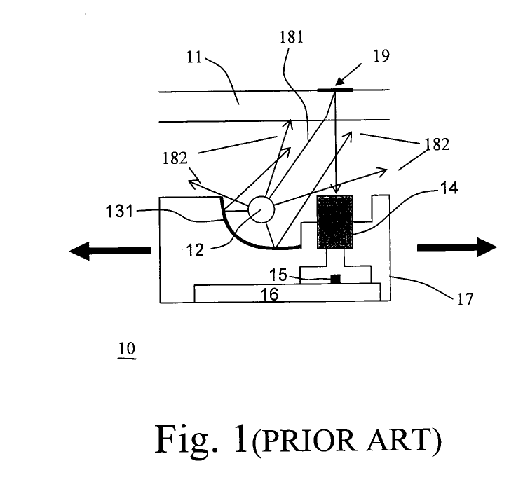

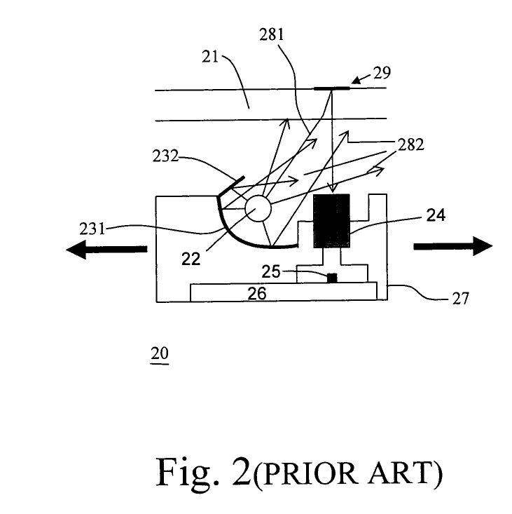

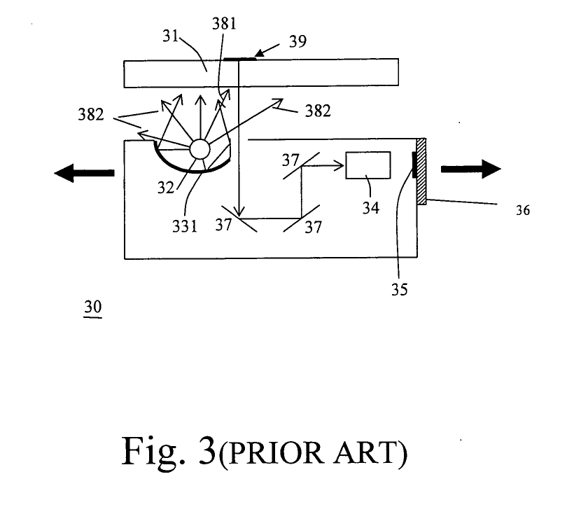

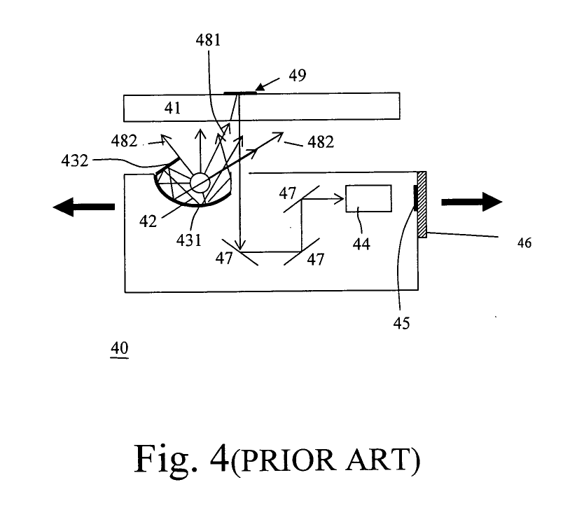

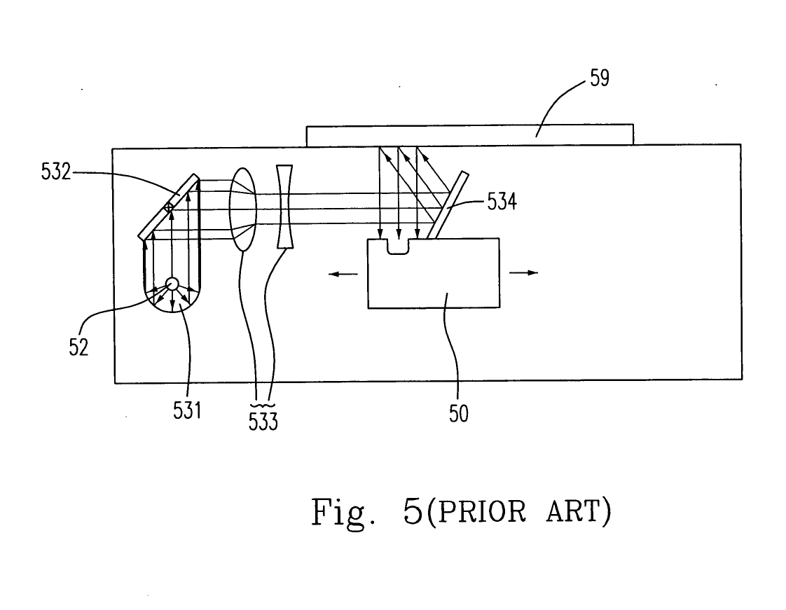

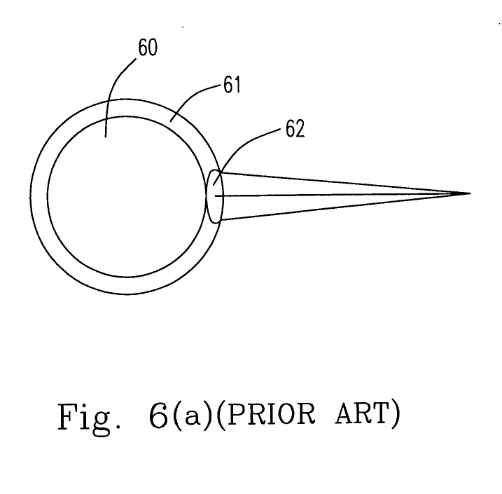

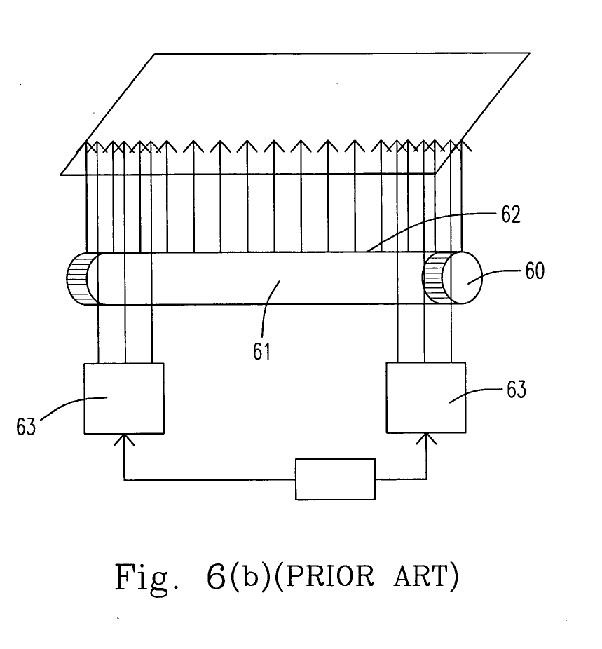

### DETAILED DESCRIPTION OF THE PREFERRED EMBODIMENT

The invention is described more specifically with reference to the following embodiments. It is to be noted that the following descriptions of preferred embodiments of this invention are presented herein for the purpose of illustration and description only; it is not intended to be exhaustive or to be limited to the precise form disclosed.

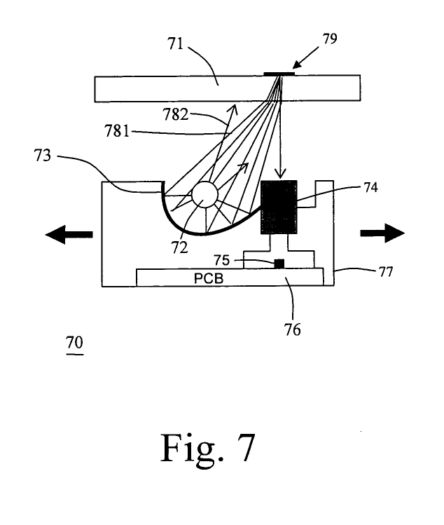

Please refer to FIG. 7 showing the light-gathering structure for the scanning module according to the first embodiment of the present invention, wherein the scanning module is a contact image sensor module (CISM).

As shown in FIG. 7, the scanning module 70 includes the cover glass 71, the light source 72, the elliptic arc surface 73, the rod lens 74, the light-sensing element 75, the circuit board 76 and the housing 77. The light source 72 can be a fluorescent lamp, a cold cathode fluorescent lamp or a xenon lamp. The elliptic arc surface 73 can be formed externally on the housing 77 by assembling, adhesion, screwing, wedging, bolting and integrally formation. The reflective film or the reflective materials can be attached or coated on the elliptic arc surface 73, so that the uniformity of the light intensity on the scanning area 79, which is positioned on the cover glass 71 or has a distance away from the cover glass 71 can meet the different requirements.

The elliptic arc surface 73 has two foci, the first focus and the second focus. The light source 72 is positioned on the first focus, and the second focus is positioned in response to the scanning area 79, the thickness of the cover glass 71, the refractive index of the cover glass 71 and the requirements of the scanning module 70.

In accordance with the present invention, most light emitted from the light source 72 is reflected by the elliptic arc surface 73 and converged to the second focus, i.e. the scanning area 79, as the effective light 781, and furthermore the ineffective light 782 is rare.

Certainly, the light-gathering structure of the present invention can not only used for the contact image sensor module (CISM), but also for the charge coupled device module (CCDM).

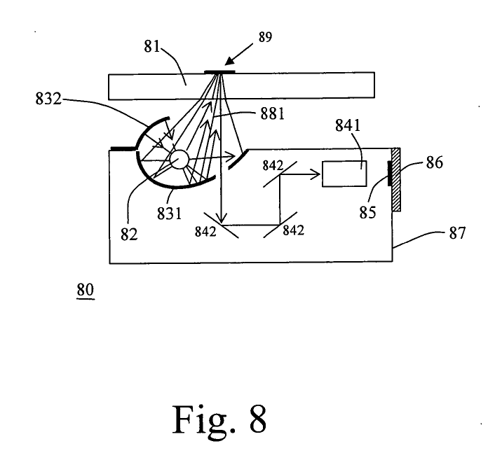

Please refer to FIG. 8 showing the light-gathering structure for the scanning module according to the second embodiment of the present invention. In contrast with the light-gathering structure shown in FIG. 7, the scanning module 80 not only includes the elliptic arc surface 831, but also has the circular arc surface 832, wherein the circular center of the circular arc surface 832 is superpositioned on the first focus of the elliptic arc surface 831. Furthermore, the scanning module 80 has a set of mirrors 842 for reflecting the light, which is reflected to the scanning area 89 by the elliptic arc surface 831 and the circular arc surface 832, to the lens 841.

Similarly, in accordance with the present invention, most light emitted from the light source 82 is reflected by the elliptic arc surface 831 and the circular arc surface 832 and converged to the second focus, i.e. the scanning area 89, as the effective light 881, and furthermore the ineffective light is rare. In addition, the light-gathering shown in FIG. 8 can be used for the contact image sensor module (CISM).

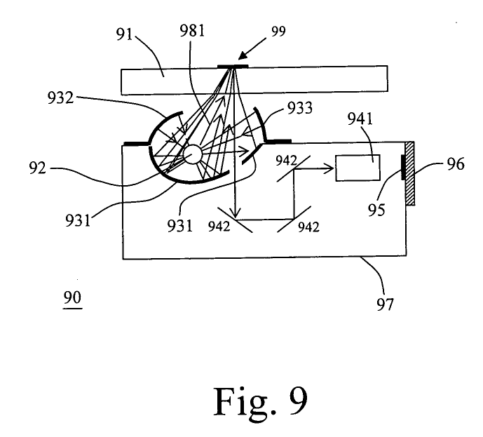

Please refer to FIG. 9 showing the light-gathering structure for the scanning module according to the third embodiment of the present invention. In contrast with the light-gathering structure shown in FIG. 8, the scanning module 90 not only includes the elliptic arc surface 931, but also has two circular arc surfaces 932 and 933, wherein the circular centers of the circular arc surfaces 932 and 933 are superpositioned on the first focus of the elliptic arc surface 931. Furthermore, the scanning module 90 has a set of mirrors 942 for reflecting the light, which is reflected to the scanning area 99 by the elliptic arc surface 931 and the circular arc surfaces 932 and 933, to the lens 941.

In accordance with the present invention, most light emitted from the light source 92 is reflected by the elliptic arc surface 931 and the circular arc surfaces 932 and 933 and converged to the second focus, i.e. the scanning area 99, as the effective light 981, and furthermore the ineffective light is rare. In this embodiment, much more ineffective light is transferred into the effective light 981, so that the light intensity on the scanning area 99 is significantly increased.

The light-gathering structure in the third embodiment of the present invention can not only used for the charge coupled device module (CCDM), but also for the contact image sensor module (CISM).

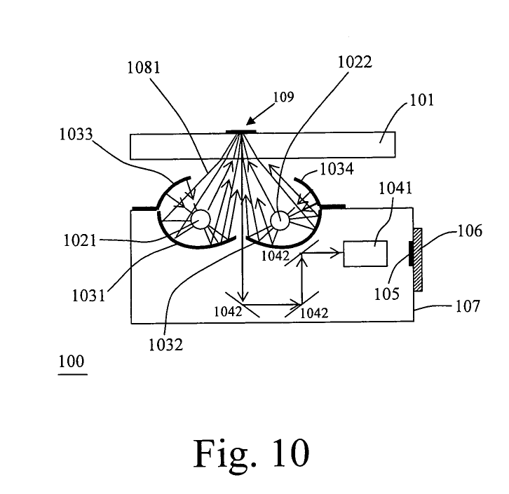

Please refer to FIG. 10 showing the light-gathering structure for the scanning module according to the fourth embodiment of the present invention. In contrast with the light-gathering structure shown in the foresaid embodiments, the scanning module 100 includes two elliptic arc surfaces 1031, 1032 and two circular arc surfaces 1033, 1034, the circular centers of the circular arc surface 1033 and 1034 are respectively superpositioned on the first foci of the elliptic arc surfaces 1031 and 1032, and the light sources 1021 and 1022 are respectively positioned on the circular centers of the circular arc surfaces 1033 and 1034.

Similarly, in accordance with the present invention, most light emitted from the light sources 1021 is reflected by the elliptic arc surface 1031 and the circular arc surfaces 1033 and converged to the second focus, i.e. the scanning area 109, as the effective light 1081, the most light emitted from the light sources 1022 is reflected by the elliptic arc surface 1032 and the circular arc surfaces 1034 and converged to the second focus, i.e. the scanning area 109, as the effective light 1081, and furthermore the ineffective light is rare. In this embodiment, the two light sources 1021 and 1022 are simultaneously used for increasing the light intensity on the scanning area 109, so as to speed up the scanning. Certainly, the light-gathering structure in the fourth embodiment of the present invention can not only used for the charge coupled device module (CCDM), but also for the contact image sensor module (CISM).

In accordance with the light-gathering structure of the present invention, the light source is positioned on the common circular center of the elliptic arc surface and the circular arc surface. The ineffective light is guided to the scanning area by the reflection characteristics of the elliptic arc surface and the circular arc surface. In the present invention, the light intensity on the scanning area is significantly increased, and the uniformity of the light intensity on the two ends of the light source can be improved by regulating the reflective index of the reflecting surface or by placing the circular arc surface on the end of the light source. The light intensity and the uniformity thereof are conducive to the scanning and the improvement of the image quality. In addition, the light-gathering structure can be molded with the scanning module, so as to minimize the scanning module and further to decrease the cost.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light-gathering structure for a scanning module having at least a scanning area, a lens and a light-sensing element, comprising:
at least an elliptic arc surface having a first focus;
at least a circular arc surface having a circular center being superpositioned on said first focus; and
at least a light source positioned at said first focus,
wherein a light from said light source is reflected by said elliptic arc surface and said circular arc surface to said scanning area and converged on said light-sensing element through said lens.

2. The light-gathering structure according to claim 1, wherein said scanning module is a contact image sensor module (CISM), and said lens is a rod lens.

3. The light-gathering structure according to claim 1, wherein said scanning module is a charge coupled device module.

4. The light-gathering structure according to claim 3, further comprising a plurality of mirrors for reflecting said light, which is reflected to said scanning area, to said lens.

5. The light-gathering structure according to claim 1, further comprising a cover glass having said scanning area thereon.

6. The light-gathering structure according to claim 5, wherein said elliptic arc surface has a second focus, which is positioned in response to said scanning area, a refractive index of said cover glass and requirements of said scanning module.

7. The light-gathering structure according to claim 1, further comprising a housing integrally formed with said elliptic arc surface and said circular arc surface.

8. The light-gathering structure according to claim 1, wherein said circular arc surface is positioned on an end of said light source.

9. The light-gathering structure according to claim 1, further comprising at least a reflection layer formed on said elliptic arc surface and said circular arc surface.

10. The light-gathering structure according to claim 1, wherein said light source is one selected from a group consisting of a fluorescent lamp, a cold cathode fluorescent lamp and a xenon lamp.

11. A light-gathering structure for a scanning module having at least a scanning area, a lens and a light-sensing element, comprising:
at least an elliptic arc surface having a first focus; and
at least a light source positioned at said first focus,
wherein a light from said light source is reflected by said elliptic arc surface and said circular arc surface to said scanning area and converged on said light-sensing element through said lens,

12. The light-gathering structure according to claim 11, wherein said scanning module is a contact image sensor module (CISM).

13. The light-gathering structure according to claim 12, wherein said lens is a rod lens.

14. The light-gathering structure according to claim 11, wherein said scanning module is a charge coupled device module.

15. The light-gathering structure according to claim 14, further comprising a plurality of mirrors for reflecting said light, which is reflected to said scanning area, to said lens.

16. The light-gathering structure according to claim 11, further comprising a cover glass having said scanning area thereon.

17. The light-gathering structure according to claim 16, wherein said elliptic arc surface has a second focus, which is positioned in response to said scanning area, a refractive index of said cover glass and requirements of said scanning module.

18. The light-gathering structure according to claim 11, further comprising a housing integrally formed with said elliptic arc surface.

19. The light-gathering structure according to claim 11, further comprising at least a reflection layer formed on said elliptic arc surface.

20. The light-gathering structure according to claim 11, wherein said light source is one selected from a group consisting of a fluorescent lamp, a cold cathode fluorescent lamp and a xenon lamp.
